(19) United States
(12) Patent Application Publication
(10) Pub. No.: US 2019/0278861 A1
(43) Pub. Date: Sep. 12, 2019

(54) Real Time Metric Interface System and Method for Information Assurance Technologies

(71) Applicant: SPAWAR Systems Center Pacific, San Diego, CA (US)

(72) Inventors: Jose Romero-Mariona, San Diego, CA (US); John San Miguel, Winchester, CA (US); Megan Kline, Chula Vista, CA (US); Keyur Parikh, San Diego, CA (US); Roger Hallman, San Diego, CA (US)

(73) Assignee: United States of America as represented by Secretary of the Navy, San Diego, CA (US)

(21) Appl. No.: 15/914,148

(22) Filed: Mar. 7, 2018

(51) Int. Cl. G06F 17/30

(52) U.S. Cl. CPC G06F 17/30539; G06F 17/30339

(57) ABSTRACT

A method and system which enable the visualization of real time adjustments to assigned values and value weights in a dataset. The method and system allow information assurance operators to broadly evaluate and assign values to the different capabilities of a technology at varying levels of granularity and visualize the manner in which changes in actual values or the weight given to such values at the different levels of granularity influence the evaluation.

### STATEMENT OF GOVERNMENT INTEREST FEDERALLY SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif. 92152; telephone (619) 553-5118; email: ssc_pac_t2@navy.mil. Reference Navy Case No. 103,514.

### BACKGROUND OF THE INVENTION

### Field of the Invention

This invention relates generally to a metric interface system and method for information assurance technologies.

### Description of the Prior Art

The use of various information assurance (“IA”) technologies to ensure the confidentiality, possession, control, integrity, authenticity, availability and utility of information and information systems is well established. Indeed, for many large institutions, IA is one of the top priorities. IA technologies are constantly evolving to protect critical information from the growing number of cyber threats. Furthermore, some institutions spend millions of dollars each year procuring, maintaining, and discontinuing various IA and cyber technologies.

Today, there are no proper metrics with which to measure how well IA technologies satisfy specific institutional requirements. In addition, metrics used across the institutions are often non-standardized, which renders them useless under new applications. In addition, there is an obvious lack of security metrics visualization to enable rapid decision making across various levels of complexity.

### SUMMARY OF THE INVENTION

The present disclosure describes a system and method for real time metric interface for information assurance technologies. In accordance with one embodiment of the present disclosure, a system is provided which includes: a computer having a processor, a user input interface, and an optical output interface and a database accessible by said processor, wherein said database is adapted to store in said non-volatile memory a value assigned to each of a plurality of top level entries, mid level entries, and low level entries and weights assigned to at least one of the plurality of top level entries, mid level entries, and low level entries. The value assigned to each of the plurality of top level entries is directly calculated from the value from at least one associated mid level entry of the plurality of mid level entries combined with any weight assigned to the associated the mid level entry. The value assigned to each of the plurality of mid level entries is directly calculated from the value from at least one associated low level entry of the plurality of low level entries combined with any weight assigned to the associated the low level entry. The system also includes an extraction module, a weight modifier module, a score modifier module, and a computation module which act on the information in the database to provide a visualization that contextualizes various changes to the information.

### BRIEF DESCRIPTION OF THE DRAWINGS

FIG. 1 shows the components of a real time metric interface system and method for information assurance technologies in accordance with the present invention.

FIG. 2 shows the process through which a real time metric interface system and method for information assurance technologies is applied to enable real time visualization of adjustment to database values.

### DETAILED DESCRIPTION OF THE INVENTION

Described herein are a method and system which enable the visualization of real time adjustments to assigned values and value weights in a dataset. It is contemplated that in building a dataset with values and weights, the first, and most basic, step is to develop metrics and determine the best way to apply them. In one embodiment, ten different metrics areas, referred to as capabilities, are utilized in order to provide relevant metrics to a variety of IA technologies. These capabilities represent the highest level of granularity and cover aspects across two main areas: Computer Network Defense (“CND”) concepts and product-level concepts. In one embodiment, five types of capabilities are provided under the CND area and five types of capabilities under the product-level area.

The method and system allow information assurance operators to broadly evaluate and assign uniform baseline values to the different capabilities of a technology at varying levels of granularity. The method and system also allow information assurance operators to visualize the baseline values or the values that have been given selected weights at the different levels of granularity influence the evaluation.

The CND-level area metrics refer to the basic aspects related to security, i.e. how well a technology supports the protection, monitoring, detection, analysis, planning, and response to threats and/or attacks. These types of metrics are more associated with aspects that government programs are interested in. The product-level area metrics refer to aspects more commonly associated with “day-to-day” operations of a technology. Product-level metrics look at aspects that range from the cost of deploying a specific technology to the difficulty of deploying a specific technology, and even further, to the complexity of maintaining that technology once it is deployed.

It is further contemplated that a fixed scoring structure must be deployed in order to enable the proper measurement of security features. A key component which enables the operation of the present interface system and method is the use of security metrics granularity; this allows for the scoring of security features to be done at various levels of complexity. Once baseline values are established through the provision of scores, the technique described herein enables the manipulation of these metric values in order to better understand the technology through various perspectives. By also employing a granularity approach to metrics manipulation, enhanced flexibility as well as reusability of results is provided.

For example, in a scenario wherein “agency 1” completes an evaluation of “technology X” with a big emphasis on the cost, and now “agency 2” wants to evaluate the same “technology X” but with a different emphasis on the protection capabilities, the present system and method allow “agency 2” to reuse the same dataset that “agency 1” produced, and manipulate the metrics to put more weight into the protection aspects of the results (and less on the cost aspects) in order to obtain a different perspective on the ability of “technology X” to meet those needs.

In an institutional environment, institution-centric and independent technology evaluation capability metrics prescribe three levels of complexity: capabilities, sub-capabilities, and sub-capability elements, with the capabilities being top level entries, the sub-capabilities being mid level entries, and the sub-capability elements being low level entries. So in such a framework, a capability-like protection can be composed of two sub-capabilities, vulnerability protection and listing (which refer to two possible ways to achieve protection), and these are further broken into sub-capability elements, like vulnerability scanning and vulnerability reporting (which also refer to two possible ways to achieve vulnerability protection) for vulnerability prevention and blacklisting for listing.

This granular approach prescribes a few rules:
Every capability is composed of one or more sub-capabilities;
Every sub-capability is composed of one or more sub-capability elements; and
Sub-capability elements can be duplicated across other sub-capabilities.

In such a framework, an aggregated “score” for a capability could be computed from various levels of granularity, meaning that the value of a capability will inherently account for the values of the sub-capabilities and sub-capability elements associated with that capability (capability->sub-capability->sub-capability element). In addition, weights could be assigned at each level to facilitate the flexibility and reuse of the metrics.

This granular system is what would enable “agency 2,” from the earlier example, to take the results from “agency 1” and apply different weights to their scores in order to emphasize different aspects of interest.

Integrated with the metric manipulation is metrics visualization for the manipulation of the various scores and weights applied to the evaluation results, so that users can see in real-time the effect that changes have on the original results.

The metrics visualization component is mainly driven by a graphical user interface (GUI) and changes made to the original results may be exported to an external storage device. As is discussed below, only the baseline metric values may be stored in the on board database.

In some embodiments, the visualization of metrics also supports decision-making by employing Bayesian-Network models in order to provide probabilities as well as return on investment (ROI) information.

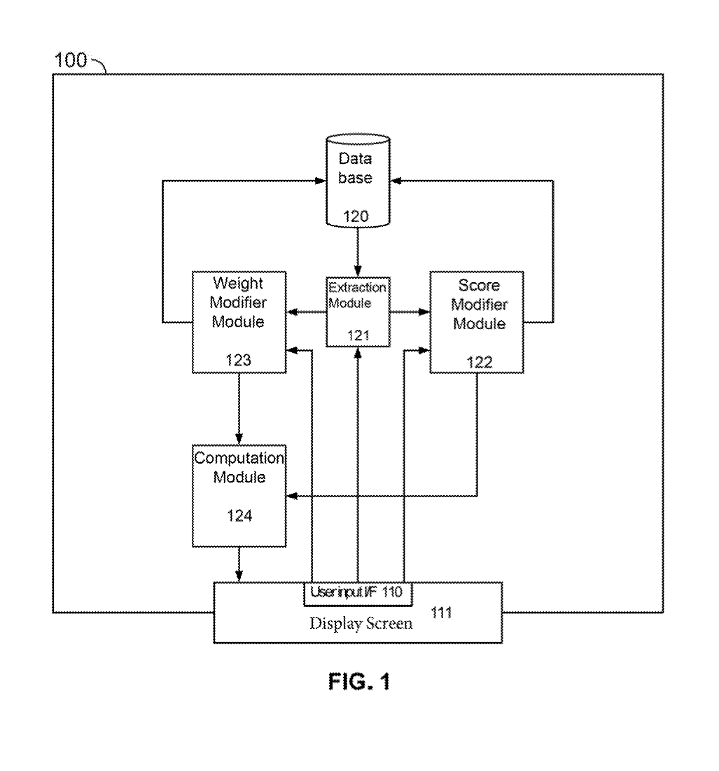

Referring now to FIG. 1, a real time metric interface system and method for information assurance technologies may be implemented on a computer system 100 which includes a processor, volatile memory, non-volatile memory, a user input interface 110 (such as a keyboard, mouse, or touch screen), and an optical output interface such as a display screen 111. In addition to a database 120 housing an initial dataset that is defined by baseline values and stored on non-volatile memory, an extraction module 121, a score modifier module 122, a weight modifier module 123, and a computation module 124 are also embodied in software housed on or available to the computer system 100 so as to each adapt the processor to perform the respective functions detailed below. It is appreciated that, based on commands received through the user input interface 110, aspects of data from the database 120 may be retrieved, extracted, and modified, in the volatile memory and then provided to the display screen 111 for viewing by a user or exported to an external storage device 130.

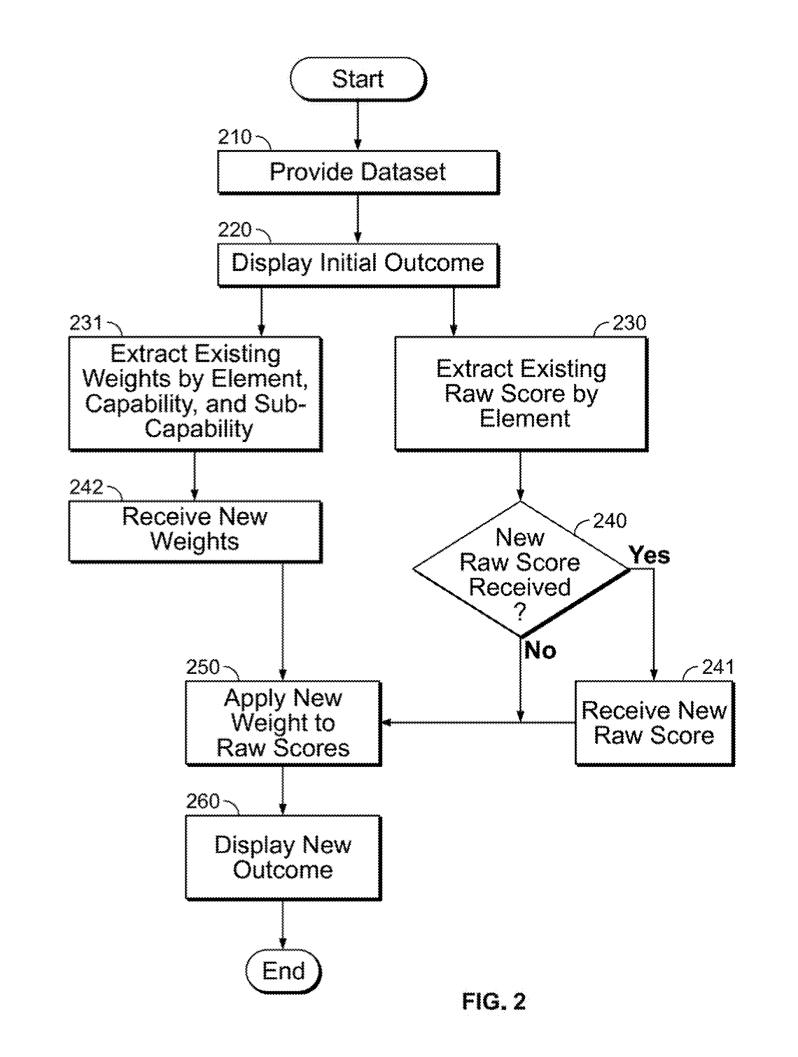

Referring now to FIG. 2, the manner in which the real time metric interface system and method for information assurance technologies is applied to enable real time manipulation to database values while ensuring the integrity of the database values begins with the step 210 of providing a dataset. It is contemplated that a dataset would be provided by being uploaded or otherwise availed to the database present on the non-volatile memory of the computer system on which the instant invention is implemented. It is further contemplated that the dataset will include or comprise data which includes baseline scores (i.e., raw scores and weighted scores if weights have been applied to the values as part of the baseline score) for each capability, sub-capability, and sub-capability element that is the subject of an evaluation. Once the dataset is provided, the dataset is displayed on the display screen on the computer system on which the instant invention is implemented at step 220. This step 220 provides a reference visualization which allows for changes which occur in the visualization. These changes occur as a result of the calculations performed by the computation module in step 250 and leading up to step 250.

Next, the extraction module on the computer system on which the instant invention is implemented extracts from the dataset any weight that has been applied to a capability, sub-capability, and sub-capability element as well as the scores that have been assigned to each sub-capability element at steps 230 and 231. It is appreciated that because the scores of the sub-capability element are used to compute the scores of the sub-capabilities, and ultimately the capabilities, then extracting the scores of the sub-capability elements is required to enable a true manipulation of the scores and/or evaluation. As a part of the extraction, the extraction module passes the extracted scores to the score modifier module on the computer system on which the instant invention is implemented and passes the extracted weights to the weight modifier module on the computer system on which the instant invention is implemented, keeping at all times the extracted scores and extracted weights in the volatile memory of the computer system and out of the database in its non-volatile memory to ensure the integrity of the baseline scores.

Because it is not a given that a user seeking a different perspective on an evaluation will want to modify the actual scores given to the sub-capability elements of a technology, the score modifier module begins at step 240 by determining if a user has provided any new score data. If not, the score modifier module simply passes the extracted scores to the computation module on the computer system on which the instant invention is implemented. If one or multiple new scores for sub-capability elements are received, the score modifier module overwrites (i.e., replaces) the extracted score with the new one for any affected sub-capability element at step 241 and then passes all of the scores (including the extracted scores that have not been overwritten and the replaced scores that have been inserted) to the computation module, keeping at all times the scores being passed in the volatile memory of the computer system and out of the database in its non-volatile memory to ensure the integrity of the baseline scores.

Upon receipt of the extracted weights, the weight modifier module overwrites (i.e., replaces) the extracted weight with the new one for any affected capability, sub-capability, and sub-capability element at step 242 and then passes all of the weights (including the extracted weights that have not been overwritten and the replaced weights that have been inserted) to the computation module, keeping at all times the weights being passed in the volatile memory of the computer system and out of the database in its non-volatile memory to ensure the integrity of the baseline scores.

Upon receipt of the set of scores from the score modifier module and the set of weights from the weight modifier module, the computation module computes the new weighted scores for each sub-capability element. Then, using the new weighted score for the sub-capability elements, the computation module computes the new weighted scores for each sub-capability and finally, using the new weighted score for the sub-capabilities, computes the new weighted scores for each capability at step 250. The new weighted scores are then provided as an updated dataset to the display screen and displayed thereon at step 260. At this time, the new weighted scores may also be exported to an external device for storage. In any event, the new weighted scores are never moved into the database in the non-volatile storage of the computer system.

It is appreciated that in some embodiments, the computation module performs its action automatically upon the receipt of the set of scores from the score modifier module and the set of weights from the weight modifier module. Similarly, in some embodiments, the score modifier module and/or the weight modifier module performs their respective actions automatically upon the receipt of an input from the extraction module.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A real time metric interface system for information assurance technologies, comprising:
a computer having a processor, non-volatile memory, a user input interface, and an optical output interface;
a database accessible by said processor, wherein said database is adapted to store in said non-volatile memory a value assigned to each of a plurality of top level entries, mid level entries, and low level entries and weights assigned to at least one of the plurality of top level entries, mid level entries, and low level entries such that the value assigned to each of the plurality of top level entries is directly calculated from the value from at least one associated mid level entry of the plurality of mid level entries combined with any weight assigned to the associated the mid level entry and the value assigned to each of the plurality of mid level entries is directly calculated from the value from at least one associated low level entry of the plurality of low level entries combined with any weight assigned to the associated the low level entry;
an extraction module integral with said processor, wherein said extraction module adapts the processor to extract values assigned to each low level entry to create extracted values as well as extract any weights assigned to any of the plurality of top level entries, mid level entries, and low level entries to create extracted weights while keeping all of said extracted values and extracted weights out of said non-volatile memory;
a weight modifier module integral with said processor, wherein said weight modifier module adapts the processor to selectively replace any extracted weight assigned to any of the plurality of top level entries, mid level entries, and low level entries while keeping all weights that have been replaced out of said non-volatile memory; and
a computation module integral with said processor, wherein said computation module adapts the processor to compute a weighted score for each low level entry from the value assigned to each respective low level entry and any weight assigned to the respective low level entry, and then, using the weighted score computed for each low level entry, compute a weighted score for each mid level entry from the weighted score for each associated low level entry and any weight assigned to the respective mid level entry and finally, using the weighted score computed for each mid level entry, compute a weighted score for each top level entry from the weighted score for each associated mid level entry and any weight assigned to the respective top level entry while keeping all weighted scores out of said non-volatile memory.

2. The real time metric interface system for information assurance technologies of claim 1, additionally comprising a score modifier module integral with said processor, wherein said score modifier module adapts the processor to selectively replace any value assigned to any of the plurality of low level entries while keeping all values that have been replaced out of said non-volatile memory.

3. The real time metric interface system for information assurance technologies of claim 2, wherein said computation module adapts the processor to compute a weighted score for each low level entry, mid level entry, and top level entry in response to at least one of the weight modifier module replacing any weight assigned to any of the plurality of top level entries, mid level entries, and low level entries and the score modifier replacing any value assigned to any of the plurality of low level entries.

4. The real time metric interface system for information assurance technologies of claim 2, wherein said computation module adapts the processor to compute a weighted score for each low level entry, mid level entry, and top level entry in response to the weight modifier module replacing any extracted weight assigned to any of the plurality of top level entries, mid level entries, and low level entries and the score modifier replacing any value assigned to any of the plurality of low level entries.

5. The real time metric interface system for information assurance technologies of claim 2, wherein said score modifier module adapts the processor to selectively replace any value assigned to any of the plurality of low level entries in response to receiving extracted values from the extraction module.

6. The real time metric interface system for information assurance technologies of claim 1, wherein said optical output interface is adapted to output information stored on the database and information computed by the computation module.

7. The real time metric interface system for information assurance technologies of claim 1, wherein said weight modifier module adapts the processor to selectively replace any extracted weight assigned to any of the plurality of top level entries, mid level entries, and low level entries in response to receiving the extracted weights from the extraction module.

8. The real time metric interface system for information assurance technologies of claim 1, wherein said computation module adapts the processor to compute a weighted score for each low level entry, mid level entry, and top level entry in response to the weight modifier module replacing any extracted weight assigned to any of the plurality of top level entries, mid level entries, and low level entries.

9. A real time metric interface system for information assurance technologies, comprising:
a computer having a processor, non-volatile memory, a user input interface, and an optical output interface;
a database accessible by said processor, wherein said database is adapted to store in said non-volatile memory a value assigned to each of a plurality of top level entries, mid level entries, and low level entries and weights assigned to at least one of the plurality of top level entries, mid level entries, and low level entries such that the value assigned to each of the plurality of top level entries is directly calculated from the value from at least one associated mid level entry of the plurality of mid level entries combined with any weight assigned to the associated the mid level entry and the value assigned to each of the plurality of mid level entries is directly calculated from the value from at least one associated low level entry of the plurality of low level entries combined with any weight assigned to the associated the low level entry;
an extraction module integral with said processor, wherein said extraction module adapts the processor to extract values assigned to each low level entry to create extracted values as well as extract any weights assigned to any of the plurality of top level entries, mid level entries, and low level entries to create extracted weights while keeping all of said extracted values and extracted weights out of said non-volatile memory;
a score modifier module integral with said processor, wherein said score modifier module adapts the processor to selectively replace any value assigned to any of the plurality of low level entries in response to receiving extracted values from the extraction module while keeping all values that have been replaced out of said non-volatile memory;
a weight modifier module integral with said processor, wherein said weight modifier module adapts the processor to selectively replace any extracted weight assigned to any of the plurality of top level entries, mid level entries, and low level entries in response to receiving the extracted weights from the extraction module while keeping all weights that have been replaced out of said non-volatile memory; and
a computation module integral with said processor, wherein said computation module adapts the processor to compute a weighted score for each low level entry from the value assigned to each respective low level entry and any weight assigned to the respective low level entry, and then, using the weighted score computed for each low level entry, compute a weighted score for each mid level entry from the weighted score for each associated low level entry and any weight assigned to the respective mid level entry and finally, using the weighted score computed for each mid level entry, compute a weighted score for each top level entry from the weighted score for each associated mid level entry and any weight assigned to the respective top level entry while keeping all weighted scores out of said non-volatile memory.

10. The real time metric interface system for information assurance technologies of claim 9, wherein said computation module adapts the processor to compute a weighted score for each low level entry, mid level entry, and top level entry in response to at least one of the weight modifier module replacing any weight assigned to any of the plurality of top level entries, mid level entries, and low level entries and the score modifier replacing any value assigned to any of the plurality of low level entries.

11. The real time metric interface system for information assurance technologies of claim 9, wherein said computation module adapts the processor to compute a weighted score for each low level entry, mid level entry, and top level entry in response to the weight modifier module replacing any extracted weight assigned to any of the plurality of top level entries, mid level entries, and low level entries and the score modifier replacing any value assigned to any of the plurality of low level entries.

12. The real time metric interface system for information assurance technologies of claim 1, wherein said computation module adapts the processor to compute a weighted score for each low level entry, mid level entry, and top level entry in response to the weight modifier module replacing any weight assigned to any of the plurality of top level entries, mid level entries, and low level entries.

13. The real time metric interface system for information assurance technologies of claim 1, wherein said computation module adapts the processor to compute a weighted score for each low level entry, mid level entry, and top level entry in response to the score modifier replacing any value assigned to any of the plurality of low level entries.

14. The real time metric interface system for information assurance technologies of claim 9, wherein said optical output interface is adapted to output information stored on the database and information computed by the computation module.

15. A real time metric interface method for information assurance technologies, comprising the steps of:
providing a computer having a processor, non-volatile memory, a user input interface, and an optical output interface;
providing a database accessible by said processor, wherein said database is adapted to store in said non-volatile memory a value assigned to each of a plurality of top level entries, mid level entries, and low level entries and weights assigned to at least one of the plurality of top level entries, mid level entries, and low level entries such that the value assigned to each of the plurality of top level entries is directly calculated from the value from at least one associated mid level entry of the plurality of mid level entries combined with any weight assigned to the associated the mid level entry and the value assigned to each of the plurality of mid level entries is directly calculated from the value from at least one associated low level entry of the plurality of low level entries combined with any weight assigned to the associated the low level entry;
extracting by said processor values assigned to each low level entry to create extracted values as well as any weights assigned to any of the plurality of top level entries, mid level entries, and low level entries to create extracted weights while keeping all of said extracted values and extracted weights out of said non-volatile memory;
selectively replacing by said processor any extracted weight assigned to any of the plurality of top level entries, mid level entries, and low level entries while keeping all weights that have been replaced out of said non-volatile memory; and
computing by said processor a weighted score for each low level entry from the value assigned to each respective low level entry and any weight assigned to the respective low level entry, and then, using the weighted score computed for each low level entry, computing a weighted score for each mid level entry from the weighted score for each associated low level entry and any weight assigned to the respective mid level entry and finally, using the weighted score computed for each mid level entry, computing a weighted score for each top level entry from the weighted score for each associated mid level entry and any weight assigned to the respective top level entry while keeping all weighted scores out of said non-volatile memory.

16. The method of claim 15, additionally comprising the step of selectively replacing by said processor any value assigned to any of the plurality of low level entries while keeping all values that have been replaced out of said non-volatile memory.

17. The method of claim 16, wherein the step of computing is automatic in response to at least one of the step of selectively replacing by said processor any extracted weight assigned and the step of selectively replacing by said processor any value assigned.

18. The real time metric interface system for information assurance technologies of claim 15, wherein the step of selectively replacing by said processor any value assigned occurs automatically in response to step of extracting.

19. The real time metric interface system for information assurance technologies of claim 15, wherein the step of selectively replacing by said processor any extracted weight assigned occurs automatically in response to step of extracting.

20. The real time metric interface system for information assurance technologies of claim 15, wherein said optical output interface is adapted to output information stored on the database and information generated by the step of computing.
